(19) United States
(12) Patent Application Publication
(10) Pub. No.: US 2011/0157873 A1
(43) Pub. Date: Jun. 30, 2011

(54) Safety signalling device

(76) Inventor: Jerry Anthony English, Collinsville, OK (US)

(21) Appl. No.: 12/655,269

(22) Filed: Dec. 28, 2009

(51) Int. Cl. F21V 21/08; F21L 4/00

(52) U.S. Cl. 362/103; 362/190

(57) ABSTRACT

A safety signalling device is conveniently and clearly positionable upon a person or upon a vehicle upon which a person is riding in order to assure said person of a most highest quality of safety warning in relation to effects of traffic conditions. For example, whether he is walking along a street, or jogging, or riding a bicycle or motorcycle, he may always place the safety device at a position which he considers to be the most clearly visible for any motorized traffic. The multiplicity of light-emitting diodes are extremely visible to said traffic. The choice of colored diodes, such as amber or red, may be made to conform to a particular signal.

### FIELD OF THE INVENTION

My invention relates to an illuminating device which is adaptable for positioning by a person upon a chosen place to serve a person as a safety protection device during dark night conditions while a person is moving about, either on foot or riding a bicycle or motorcycle, and while traffic activity seems to be potentially dangerous.

I have constructed my safety signaling device to be easily and quickly positionable wherever the user deems most significant in relation to his immediate activity. I have relied greatly upon a wraparound capability of my safety device for most adaptable usage.

Thus, the most basic components of my invention comprise a flexible support member for a multiplicity of light-emitting diodes and necessary operating components arranged in a most efficient manner for easy and quick attachment wherever the user wishes while provided with secure holding furnished by a system of hook and loop members, such as Velcroₜₘ.

### BACKGROUND OF THE INVENTION

Many inventions have been developed to take advantage of the convenience and efficiency of small-sized electronic components such as batteries, flashlight bulbs, and light-emitting diodes Certain illuminating devices include flashlight bulbs in miniature lights to light-up small work areas, and other illuminating devices may rely on a large group of light-emitting diodes to establish a form of signal, most frequently, by using red LEDs.

The following U.S. patents illustrate such examples:

| | | |
|---|---|---|
| 5,448,458 | Sep. 5, 1995 | Douglas B. Smyly, Jr. |
| 5,882,110 | Mar. 16, 1999 | Carmen C. Rapisarda |
| 6,558,016 | May 6, 2003 | Edward C. Redtauro |
| 6,902,289 | Jun. 7, 2005 | Paul N. Smith |
| 6,902,290 | Jun. 7, 2005 | Harry L. Watts et al |
| 7,108,403 | Sep. 19, 2006 | John Walters, et al |
| 7,401,953 | Jul. 22, 2008 | Hiroyuki Isayama |
| 7,425,893 | Sep. 16, 2008 | Mathhew Randolph Aron |
| 7,537,362 | May 26, 2009 | Kazumitsu Kushida, et el |

U.S. Pat. No. 5,448,458, to D. B. Smyly, Jr. illustrates a flashlight which is mountable upon the back of a person's hand so that a beam of light may be directed toward the point where a set of hand tools are held.

U.S. Pat. No. 5,882,110, to C. C. Rapisarda describes a form of elongated, decorative, flexible, light-transmitting assembly which is affixed to the outer surface of wearing apparel.

U.S. Pat. No. 6,558,016, to E. C. Restauro shows a garment for a motorcyclist which includes various known traffic signals and which is attachable to the motorcycle power system.

U.S. Pat. No. 6,902,289, to P. N. Smith describes a hand cover which includes a first light source mounted on a lateral side of an index finger portion and a second light source mounted on a lateral side portion of the user's thumb, with a battery positioned remotely away, on the back of the hand cover.

U.S. Pat. No. 6,902,290, to H. L. Watts covers a finger-mounted LED system in which the power source is strapped to the wrist of the user and further includes power controls and a display for showing the battery level.

U.S. Pat. No. 7,108,403 to J. Walters and T. R. Walters describes two embodiments of a portable LED assembly: the first embodiment having LED mounted in a separate panel positionable in the base unit, and the second having the LED mounted directly within the base unit.

U.S. Pat. No. 7,401,953, to H. Isayama describes a motorcycle having a headlight and flasher lights mounted within a cover unit for the handlebars.

U.S. Pat. No. 7,425,893, to M. R. Aron describes a light and turn signal assembly for mounting over a motorcycle headlight.

U.S. Pat. No. 7,537,362, to K. Kushida et al describes a lighting system for a motorcycle in which the array of lights are arranged to form a face.

### SUMMARY OF THE INVENTION

The primary object of my invention is to provide a safety device for an individual in any activity or movement in which there might be the slightest chance of injury by some unexpected source, especially any activity in which the person is engaged at night. Such an activity might be that the person is riding a motorcycle or bicycle on a dark street, or walking or jogging along such dark street, or even having a need to provide signals to others within some darkened area.

In my combination, I have designed a safety device in which the components cooperate most efficiently for the safety of the user, as I clearly show in my drawings. I have placed the switch close to the source of illumination for the convenience of the user.

My initial consideration for my invention evolved from my long experience with motorcycles and electronics. I felt that there was a need for safety signals and believed that the use of light-emitting diodes would be ideal for a hand-placed signal. An array of LEDs, especially of red color, provides a very intense and attention-commanding signal, particularly on a dark night.

Eventually, I noticed other conditions which could greatly benefit with a safety device like mine, such as where a lack of sidewalks forces people to walk in the street, which is extremely dangerous on dark nights.

I designed my safety device primarily for a cyclist to wear on hi hand so that he may even provide proper traffic signals to the other traffic. Then, for walking or jogging, the safety device may be worn on an arm or leg, whichever position the user prefers. The unusual movement of the illuminator device tends to make any traffic more attentive.

My safety device comprises a strip of flexible material with wraparound capability which may be held in position by means of hook and loop components, such as Velcro members, which cooperate to form fastening members from the most comfortable on the strip, and LED members on a visible side of strip, with a battery in connection thereto, and a switch positioned for easy access.

My safety device comprises a strip of flexible material, which may be formed of two similar strips sewn together, with easy openable capability for various components protected therebetween, or separate openable compartments for various components placed at various suitable accessible positions.

For one embodiment of my safety device, one that may be worn on the hand, I show a device in which the wraparound capability is provided by a flexible strip which includes a trans-verse portion to wrap around a wrist, being held in position by cooperating areas of hook and loop members which permit quick attachment with variable sizing. Then, I found it more convenient to have a complete circular component at the other end for securing two fingers. This arrangement just happened to provide for efficient operation of the device by placing the switch in close proximity to the finger support.

### BRIEF DESCRIPTION OF THE DRAWINGS

FIG. is a perspective view of a person employing a safety device, according to my invention, for protection, as by sending various signals to potential traffic members; in this case as he might be walking on a dark night, but also, issuing known signals of his intent.

FIG. 2 is an enlarged perspective view of a safety device, according to my invention, as it is in the position demonstrated in FIG. 1, especially to demonstrate the ease of circuit control.

FIG. 3 is a perspective view of a safety device, according to my invention, showing the device in a partially closed position, to illustrate the fastening capability of the device.

FIG. 4 is a schematic diagram of the circuit of the safety device.

### DETAILED DESCRIPTION OF THE INVENTION

In FIG. 1 I describe one example of my safety device 10 as it is exhibited by a person 12 displaying common traffic signal positions with the safety device 10. The person 12 appears to be attempting to gain attention from live traffic; but, if he were on board a motorcycle or bicycle, he would be capable of displaying the same signals while riding along. The horizontal extension of the person's arm, showing the safety device as being illuminated from a multiplicity of LEDs 14 normally expresses a signal meaning “stop”, while indicating, in shadow, the left turn and right turn signals which are commonly used.

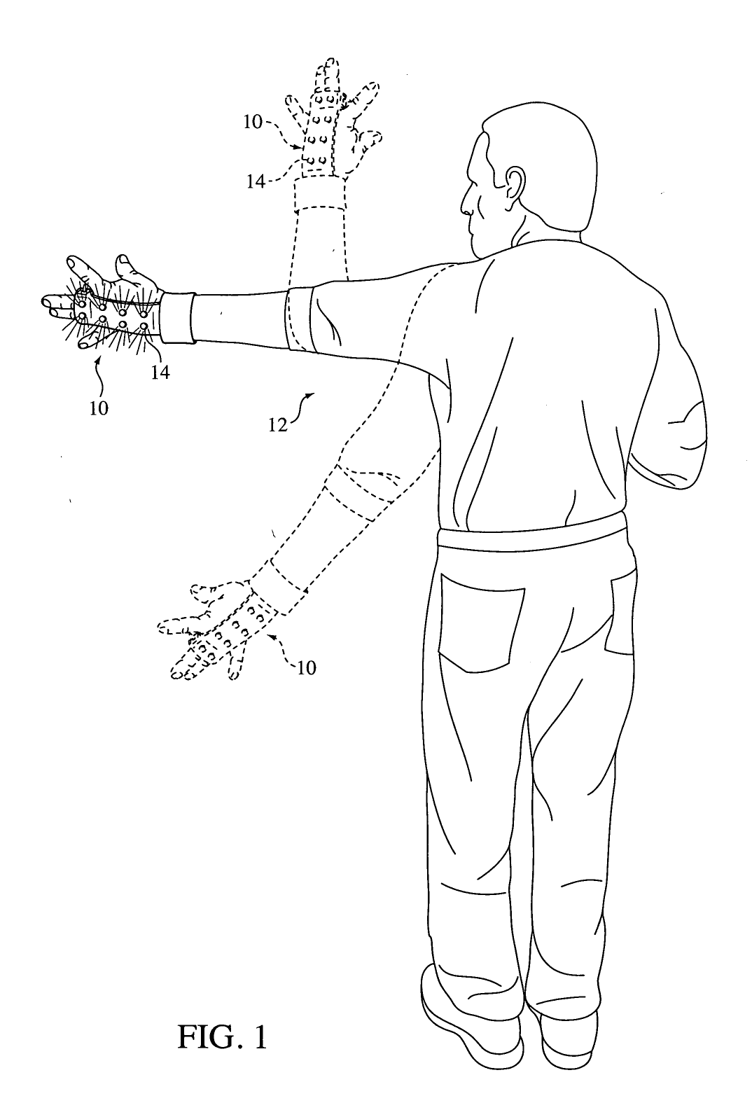

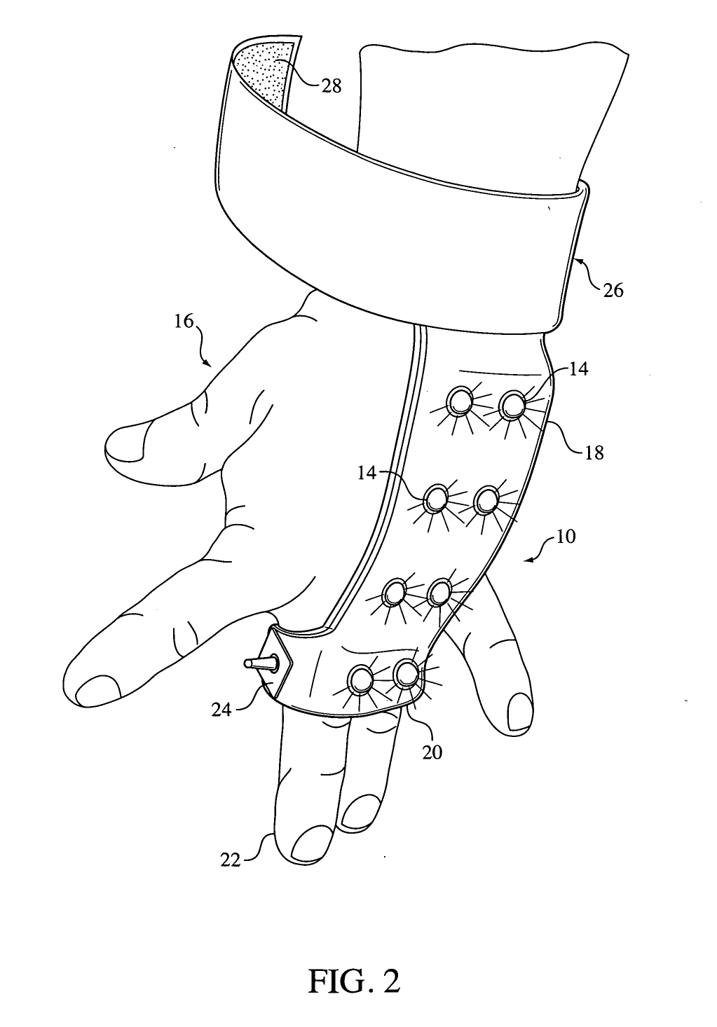

Then, in FIG. 2, I provide a more clearly detailed view of a safety device 10 in a preferred position upon a person's hand 16. I have prepared my safety device 10 out of a strip of flexible material 18, which I made from two strips of the same material, sewn together around the edges, but arranged to provide for the LEDs 14 to be placed between the two strips, but with having easy access to the LEDs 14. In this embodiment, I include a loop portion 20 to encircle one or two of the user's fingers 22 for a secure holding, and have placed a switch com-24 nearby to be easily operable by another one of the user's fingers. For wraparound convenience I provide a wrist portion 26, generally, in which the loose ends of the safety device 10 are held in an adjustable position by cooperation of hook and loop members 28.

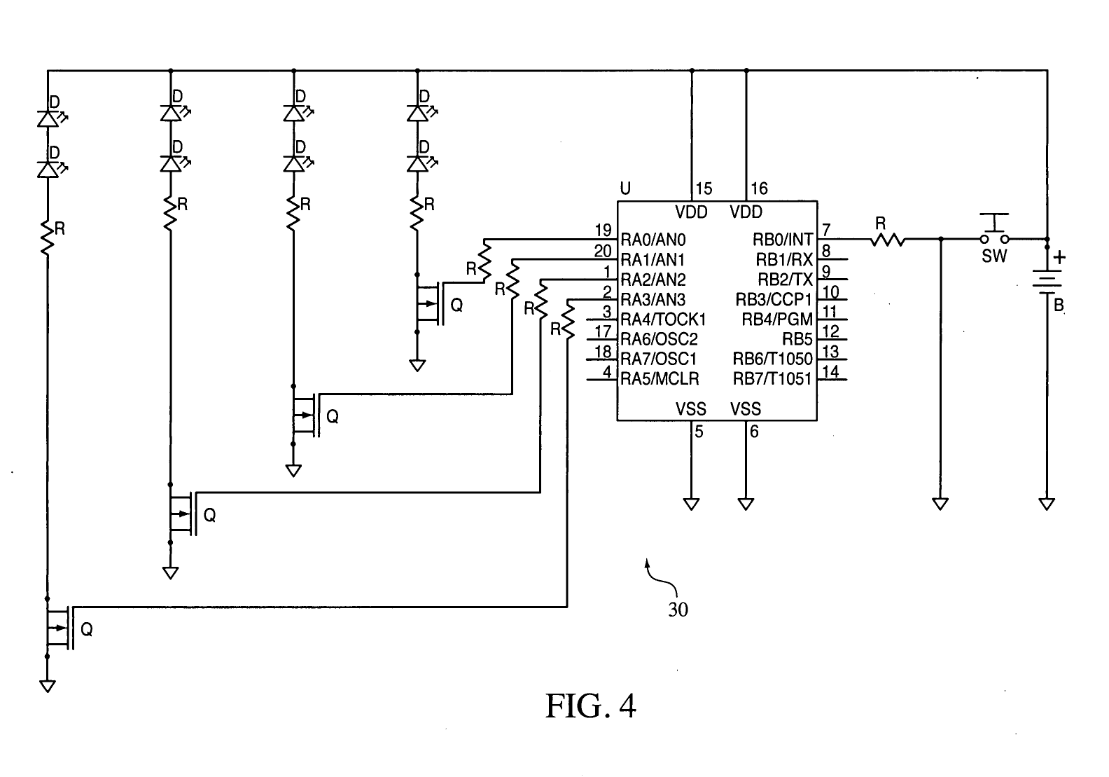

I have positioned a multiplicity of LEDs securely between the strips 18 to extend conveniently thru the upper member. And between the strips 18 I place a proper system of circuit components 30, which I show in FIG. 4, generally, for convenient connection with the LEDs 14 and switch 24.

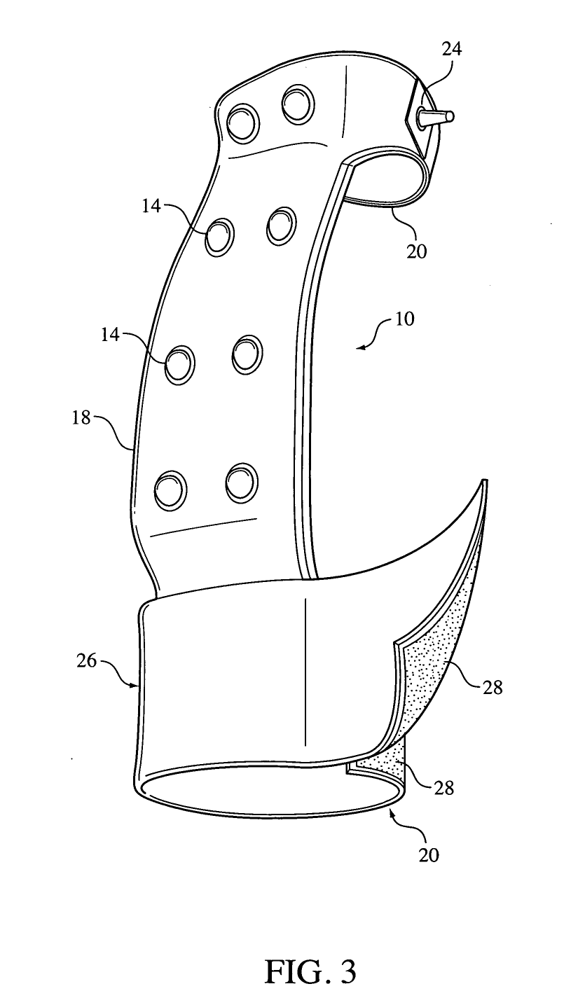

FIG. 3 describes more suitably the means I have chosen for providing accessibility for the various components and the proper choice of securing the attachment means for operation. In this FIG. 1 describe positioning of Velcro type members as they are operable for all embodiments.

Since I have illustrated and described my preferred embodiments of my invention, it is to be understood that many different embodiments of my invention may be made without departing from the spirit and scope thereof, it is to be understood that the specific embodiments described in detail herein are not to be taken in a limiting sense, since the scope of the invention is best defined by the wording of the appended claims.

I claim:

1. A light-emitting safety device for operation by a person to clearly designate the person's activity, comprising:
a strip composed of flexible material having wraparound capability,
a multiplicity of light-emitting diodes upon a side of said strip,
a battery positioned upon said strip in connection with said light-emitting diodes,
a switch positioned near an end of said strip for easy access by said person and in connection with said battery, and
said strip having easily-attachable components thereon for securing said safety device at a suitable position.

2. A safety device as described in claim 1, wherein:
said easily-attachable components are provided by cooperation of hook and loop components placed in cooperable positions on said flexible strip.

3. A safety device as described in claim 2, wherein:
wraparound capability of said strip of flexible material is provided by such length of flexible material to comprise variable positioning for a person.

4. A safety device as described in claim 3, wherein:
said strip of flexible material comprises a pair of strips fastened together to provide a space for active components.

5. A safety device as described in claim 4, wherein:
a first space is provided in relation to said flexible material for a battery, a second space is provided for a circuit for said battery, and both spaces are easily accessible.

6. A safety device as described in claim 1, wherein:
said strip of flexible material comprises a strip of variable length to encircle or leg of said person.

7. A safety device as described in claim 6, wherein:
said switch is positioned to be readily accessible for a finger of said person.

8. A safety device as described in claim 1, wherein:
said device includes a loop of flexible material adjacent an end of said strip of flexible material of a size to encircle a finger of said person.

9. A safety device as described in claim 8, wherein:
said switch is positioned on said strip in convenient access for a finger encircled by said loop.

10. A safety device as described in claim 5, wherein:
said strip of flexible material comprises a strip of variable length to encircle an arm or leg of said person.

11. A safety device as described in claim 10, wherein:
said switch is positioned to be readily accessible for a finger of said person.

12. A safety device as described in claim 5, wherein:
said device includes a loop of flexible material adjacent an end of said strip of flexible material of a size of a size to encircle a finger of said person.

13. A safety device as described in claim 12, wherein:
said switch is positioned on said strip in convenient access for a finger encircled by said loop.
